(19) United States
(12) Patent Application Publication
(10) Pub. No.: US 2005/0016000 A1
(43) Pub. Date: Jan. 27, 2005

(54) Miter frame for a circular saw

(76) Inventor: Denham Ray Stewart, Miami, FL (US)

Correspondence Address: Denham Stewart, 1430 NW 183rd St, Miami, FL, 33169, US

(21) Appl. No.: 10/397,019

(22) Filed: Jun. 16, 2003

(51) Int. Cl. B23D 45/16

(52) U.S. Cl. 30/388

(57) ABSTRACT

A miter frame for a circular saw that includes a molded plastic frame including a box having external dimension of about seven inches wide, six inches high and twenty-one inches long along a long side and about fifteen inches long along the short side; the interior dimensions of the box being approximately two and one-quarter inches deep on both sides and six inches wide; each side of the box is provided with a first saw blade guide oriented at ninety degrees with respect to the longer and the shorter sides and a second saw blade guide oriented at an angle “A” of forty-five degrees with respect to the longer and the shorter sides; use of two sides allows trim to be cut while the box is positioned on the ground; a square end of the box is provided with a forty-five degree undercut guide so that the saw blade may be tilted at a forty-five degree angle to allow ninety degree cut trim to be provided with a forty-five degree face forming ninety degree corners with two pieces of trim.

### TECHNICAL FIELD

The present invention relates to carpentry aids for doing trim work and more particularly to a miter frame for a circular saw that includes a molded plastic frame including a box having external dimension of ab out seven inches wide, six inches high and twenty-one inches long along a long side and about fifteen inches long along the short side; the interior dimensions of the box being approximately two and one-quarter inches deep on both sides and six inches wide; each side of the box is provided with a first saw blade guide oriented at ninety degrees with respect to the longer and the shorter sides and a second saw blade guide oriented at an angle “A” of forty-five degrees with respect to the longer and the shorter sides; use of two sides allows trim to be cut while the box is positioned on the ground; a square end of the box is provided with a forty-five degree undercut guide so that the saw blade may be tilted at a forty-five degree angle to allow ninety degree cut trim to be provided with a forty-five degree face forming ninety degree corners with two pieces of trim.

### BACKGROUND ART

Most trim carpentry work is done on site and most of the cuts made are straight cuts, ninety degree cuts with a forty-five degree undercut, or a forty five degree cut. It would be desirable, therefore, to have a molded plastic miter box that could be used in conjunction with a circular saw so that the trim carpenter would not need an expensive miter saw which could easily be stolen or damaged at the construction site.

### GENERAL SUMMARY DISCUSSION OF INVENTION

It is thus an object of the invention to provide a miter frame for a circular saw that includes a molded plastic frame including a box having external dimension of about seven inches wide, six inches high and twenty-one inches long along a long side and about fifteen inches long along the short side; the interior dimensions of the box being approximately two and one-quarter inches deep on both sides and six inches wide; each side of the box is provided with a first saw blade guide oriented at ninety degrees with respect to the longer and the shorter sides and a second saw blade guide oriented at an angle “A” of forty-five degrees with respect to the longer and the shorter sides; use of two sides allows trim to be cut while the box is positioned on the ground; a square end of the box is provided with a forty-five degree undercut guide so that the saw blade may be tilted at a forty-five degree angle to allow ninety degree cut trim to be provided with a forty-five degree face forming ninety degree corners with two pieces of trim.

Accordingly, a miter frame for a circular saw is provided. The miter frame for a circular saw includes a molded plastic frame including a box having external dimension of about desert inches wide, six inches high and twenty-one inches long along a long side and about fifteen inches long along the short side; the interior dimensions of the box being approximately two and one-quarter inches deep on both sides and six inches wide; each side of the box is provided with a first saw blade guide oriented at ninety degrees with respect to the longer and the shorter sides and a second saw blade guide oriented at an angle “A” of forty-five degrees with respect to the longer and the shorter sides; use of two sides allows trim to be cut while the box is positioned on the ground; a square end of the box is provided with a forty-five degree undercut guide so that the saw blade may be tilted at a forty-five degree angle to allow ninety degree cut trim to be provided with a forty-five degree face forming ninety degree corners with two pieces of trim.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a perspective view of a representative circular saw.

FIG. 2 is a top plan view of the miter frame for a circular saw.

FIG. 3 is an angled end view of the miter frame for a circular saw.

### EXEMPLARY MODE FOR CARRYING OUT THE INVENTION

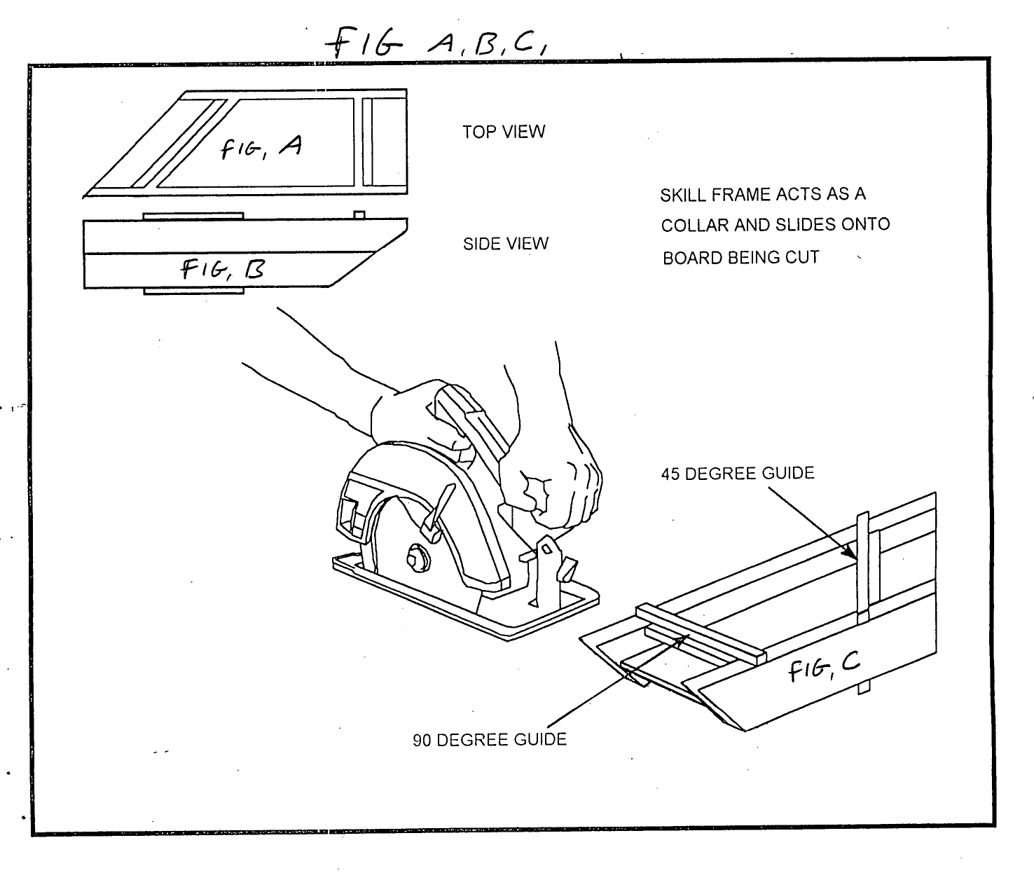

FIGS. 1-3 shows various aspects of an exemplary embodiment of the miter frame, generally designated 10, for a circular saw, generally designated 12, of the present invention. Miter frame for a circular saw 10 includes a molded plastic frame, generally designated 14 including a box, generally designated 16, having external dimension of about seven inches wide, six inches high and twenty-one inches long along a long side and about fifteen inches long along the short side; the interior dimensions 20a, 20b of the box 16 being approximately two and one-quarter inches deep on both sides and six inches wide. Each side of the box. 16 is provided with a first saw blade guide 24 oriented at ninety degrees with respect to the longer and the shorter sides 26, 28 and a second saw blade guide 30 oriented at an angle “A” of forty-five degrees with respect to the longer and the shorter sides 26, 28. The use of two sides allows trim to be cut while the box 16 is positioned on the ground. A square end 40 of box 16 is provided with a forty-five degree undercut guide 44 so that the saw blade 46 of circular saw 12 may be tilted at a forty-five degree angle to allow ninety degree cut trim to be provided with a forty-five degree face to allow for the forming ninety degree corners with two pieces of trim

It can be seen from the preceding description that a miter frame for a circular saw has been provided, Additionally, holes 8 with the frame allow a single mold manufacturing process. Using less material will not effect the strength or integrity of the frame.

It is noted that the embodiment of the miter frame for a circular saw described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense. Additionally, holes with the frame allow a single mold manufacturing process. Using less material will not effect the strength or integrity of the frame.

1. I claim that my invention (the S.M.T. frame) can assist any person using a circular skill saw to cut two common angles very fast and accurately at 45 degrees and 90 degrees on boards or trim molded wood.
